(19) United States
(12) Patent Application Publication
(10) Pub. No.: US 2011/0008627 A1
(43) Pub. Date: Jan. 13, 2011

(54) Auxiliary cushioning device

(76) Inventor: Gorden Kuo, Taichung Hsien (TW)

Correspondence Address: CHARLES E. BAXLEY, ESQUIRE, 90 JOHN STREET, SUITE 403, NEW YORK, NY, 10038, US

(21) Appl. No.: 12/459,825

(22) Filed: Jul. 8, 2009

(51) Int. Cl. B32B 27/40

(52) U.S. Cl. 428/423.1

(57) ABSTRACT

A cushioning device includes a sheet member having an upper portion covered with an air permeable material for engaging with a user, and having a bottom portion covered with an anti-slip or protruded or sticky or resilient material for stably engaging with a supporting surface, and having two upper end portions covered with an anti-slip or protruded or sticky or resilient material and foldable relative to the sheet member and faceable downwardly for engaging with the ground, the chair, the bed or the other supporting surfaces and for preventing the sheet member from slipping relative to the ground, the chair, the bed or the other supporting surfaces.

### BACKGROUND OF THE INVENTION

1. Field of the Invention

The present invention relates to a pad or cushioning device, and more particularly to a pad or cushioning device including one or more anti-slip areas or portions for engaging with the ground, the chair, the bed or the other supporting surfaces and for stably anchoring or positioning various objects to the ground, the chair, the bed or the other supporting surfaces and for preventing the objects from slipping relative to the ground, the chair, the bed or the other supporting surfaces.

2. Description of the Prior Art

Typical cushioning devices or pads or baffle construction articles comprise two layers for forming one or more chambers or compartments between the two layers and for receiving or engaging with various resilient or cushioning materials.

For example, U.S. Pat. No. 5,987,669 to Leggett et al. discloses one of the typical closed baffle construction articles filled thermal article and comprising at least one baffle made with overlapping ribbons, and the baffles are attached to either vertical channel baffles or to the sides of the article.

However, the typical closed baffle construction article includes a large volume that may not be easily carried with the users and that may not be easily attached or engaged onto the other articles or objects.

U.S. Pat. No. 6,863,958 to Wang discloses another typical cushioning device comprising a substrate sheet, bouncing cells made of elastic material convexly formed on one side of the substrate sheet.

However, similarly, the typical cushioning device also includes a large volume that may not be easily carried with the users and that may not be easily attached or engaged onto the other articles or objects.

The present invention has arisen to mitigate and/or obviate the afore-described disadvantages of the conventional cushioning devices.

### SUMMARY OF THE INVENTION

The primary objective of the present invention is to provide a cushioning device including one or more anti-slip areas or portions for engaging with the ground, the chair, the bed or the other supporting surfaces and for stably anchoring or positioning various objects to the ground, the chair, the bed or the other supporting surfaces and for preventing the objects from slipping relative to the ground, the chair, the bed or the other supporting surfaces.

In accordance with one aspect of the invention, there is provided a cushioning device comprising a sheet member including an upper portion and a bottom portion, the upper portion of the sheet member being covered with an air permeable material for engaging with a user, the bottom portion of the sheet member being covered with an anti-slip material for forming an anti-slip bottom portion and for stably engaging with a supporting surface, and the sheet member including two upper end portions covered with an anti-slip material for forming the anti-slip upper end portions which are foldable relative to the sheet member and faceable downwardly for engaging with the supporting surface and for preventing the sheet member from slipping relative to the supporting surface.

The anti-slip bottom portion of the sheet member may be covered with an anti-slip material, a protruded material, or a sticky and resilient material.

The anti-slip upper end portions of the sheet member may also be covered with an anti-slip material, a protruded material, or a sticky and resilient material. The sheet member may include one or more holes formed therein for hanging purposes.

The sheet member further includes two upper side portions covered with an anti-slip material for forming the anti-slip upper side portions which are foldable relative to the sheet member and faceable downwardly for engaging with the supporting surface and for preventing the sheet member from slipping relative to the supporting surface.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation of a cushioning device in accordance with the present invention;

FIG. 2 is an upper perspective view of the cushioning device;

FIG. 3 is a bottom perspective view of the cushioning device;

FIG. 4 is a further upper perspective view similar to FIG. 2, in which a portion of the cushioning device has been folded or curved for showing the flexibility of the cushioning device;

FIG. 5 is a still further upper perspective view similar to FIGS. 2 and 4, illustrating the other arrangement of the cushioning device; and

FIGS. 6, 7 are further upper perspective views similar to FIG. 1, illustrating the operation of the cushioning device.

### DETAILED DESCRIPTION OF THE PREFERRED EMBODIMENT

Referring to the drawings, and initially to FIGS. 1-4, a cushioning device 1 in accordance with the present invention comprises a planar or sheet-like member 10 including an upper surface or portion 11 covered or attached with a comfortable material 20 which is air and humidity permeable and which is good for absorbing water, and arranged for allowing the user to engage with the comfortable material 20 while in use. The sheet member 10 includes a bottom surface or portion 12 made or formed or covered with sticky, soft or resilient or anti-slip or protruded materials 30, such as rubber, poly urethane (PU), spongy materials, foamable materials, or the like for forming an anti-slip portion or area 12 or for forming an anti-slip bottom portion 12.

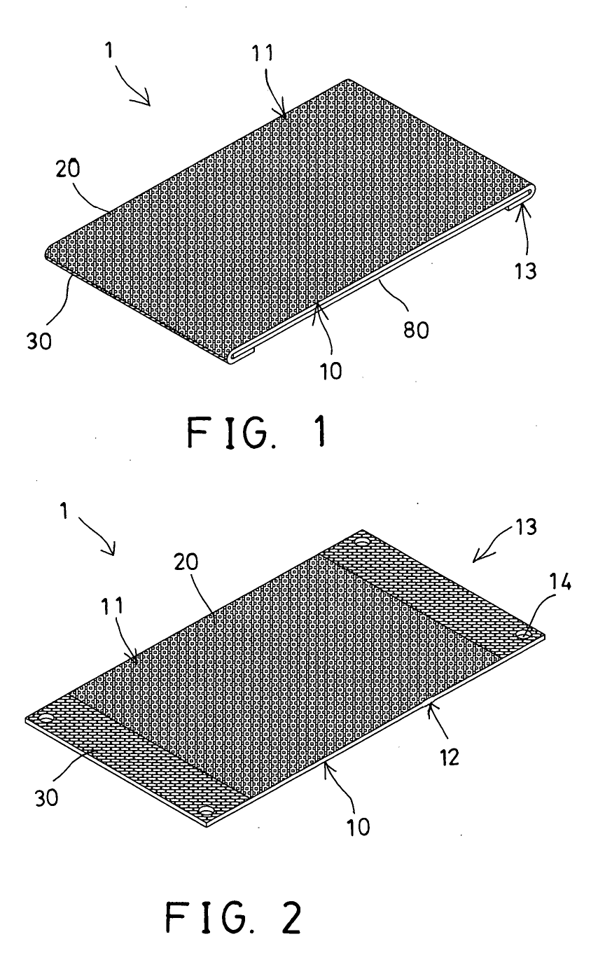

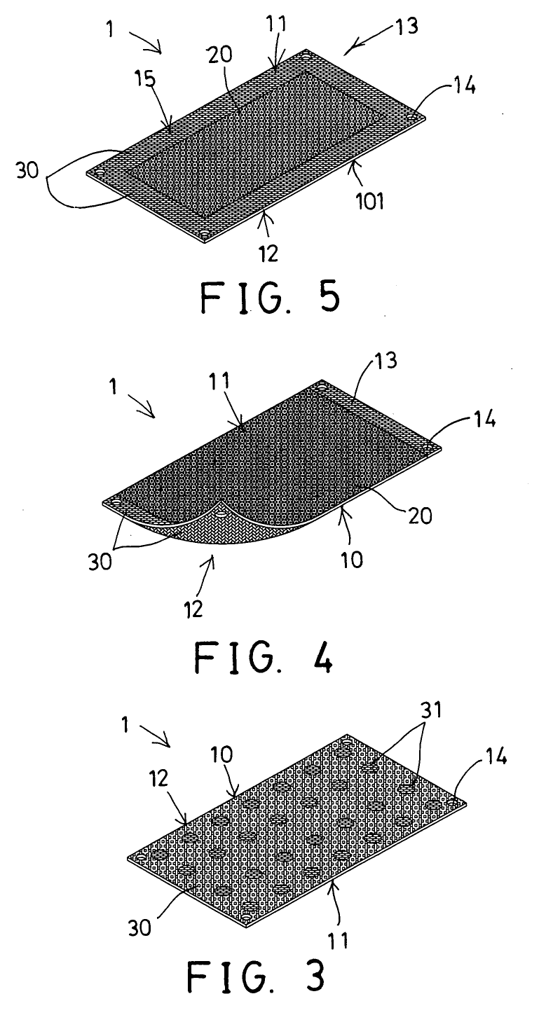

In operation, as shown in FIG. 2, when the sheet member 10 is placed or engaged onto or with the ground, the chair, the bed or the other supporting surfaces, the anti-slip bottom portion 12 of the sheet member 10 may stably anchor or position the sheet member 10 to the ground, the chair, the bed or the other supporting surfaces and may prevent the sheet member 10 from slipping relative to the ground, the chair, the bed or the other supporting surfaces. As shown in FIG. 3, the sheet member 10 may further include one or more particles or projections 31 formed or extended outwardly from the bottom portion 12 for further increasing the anti-slip characteristic to the sheet member 10 and for further preventing the sheet member 10 from slipping relative to the ground, the chair, the bed or the other supporting surfaces.

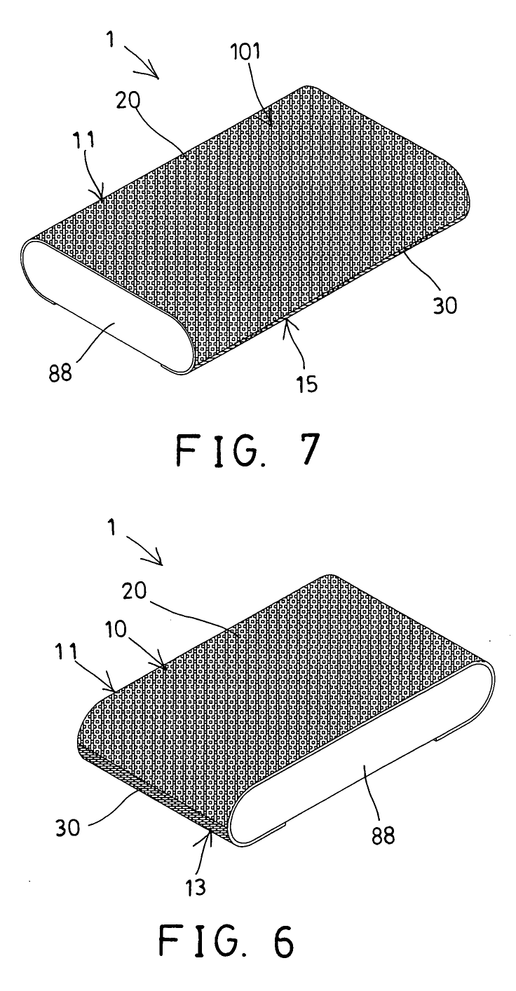

The sheet member 10 may further include one or more (such as two) opposite upper end portions 13 also made or formed with sticky, soft or resilient or anti-slip or protruded materials 30, such as rubber, poly urethane (PU), spongy materials, foamable materials, or the like for forming an anti-slip portion or area 13 or for forming the anti-slip upper end portions 13, and the two opposite anti-slip upper end portions 13 of the sheet member 10 may be folded relative to the sheet member 10 and may be faced downwardly (FIGS. 1, 6) to engage with the ground, the chair, the bed or the other supporting surfaces and to prevent the sheet member 10 from slipping relative to the ground, the chair, the bed or the other supporting surfaces. It is to be noted that the sheet member 10 may be wrapped or engaged onto the other articles or objects 80, such as another soft or resilient or anti-slip pad 80 (FIG. 1), pillow 88 (FIGS. 6, 7) or the like for stably anchoring or positioning the object 80, 88 to the ground, the chair, the bed or the other supporting surfaces and for prevent the object 80, 88 from slipping relative to the ground, the chair, the bed or the other supporting surfaces.

As shown in FIGS. 2-5, the sheet member 10 may further include one or more (such as four) holes 14 formed in the corner areas thereof for allowing the sheet member 10 to be hung or attached onto various supporting nails or protrusions or the like. As shown in FIGS. 5 and 7, the sheet member 101 may further include one or more (such as two) opposite upper side portions 15 also made or formed or covered with sticky, soft or resilient or anti-slip or protruded materials 30, such as rubber, poly urethane (PU), spongy materials, foamable materials, or the like for forming an anti-slip portion or area 15 or for forming the anti-slip upper side portions 15, and the two opposite anti-slip upper side portions 15 of the sheet member 101 may be folded relative to the sheet member 101 and may be faced downwardly to engage with the ground, the chair, the bed or the other supporting surfaces and to prevent the sheet member 101 from slipping relative to the ground, the chair, the bed or the other supporting surfaces.

In operation, as shown in FIGS. 2 and 4-5, the sheet member 10 may have the anti-slip area or bottom portion 12 directly placed or engaged onto or with the ground, the chair, the bed or the other supporting surfaces, the anti-slip bottom portion 12 of the sheet member 10 may stably anchor or position the sheet member 10 to the ground, the chair, the bed or the other supporting surfaces and may prevent the sheet member 10 from slipping relative to the ground, the chair, the bed or the other supporting surfaces. Alternatively, as shown in FIGS. 1 and 6-7, the sheet member 10 may be wrapped or engaged onto the other articles or objects 80, such as the pad 80 (FIG. 1), the pillow 88 (FIGS. 6, 7) or the like and may have the anti-slip upper end portions 13 or the anti-slip upper side portions 15 faced downwardly to engage with the ground, the chair, the bed or the other supporting surfaces and to stably anchor or position the object 80, 88 to the ground, the chair, the bed or the other supporting surfaces and to prevent the object 80, 88 from slipping relative to the ground, the chair, the bed or the other supporting surfaces.

Accordingly, the cushioning device in accordance with the present invention includes one or more anti-slip areas or portions for engaging with the ground, the chair, the bed or the other supporting surfaces and for stably anchoring or positioning various objects to the ground, the chair, the bed or the other supporting surfaces and for preventing the objects from slipping relative to the ground, the chair, the bed or the other supporting surfaces.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cushioning device comprising:
a sheet member including an upper portion and a bottom portion, said upper portion of said sheet member being covered with an air permeable material for engaging with a user, said bottom portion of said sheet member being covered with an anti-slip material for forming an anti-slip bottom portion and for stably engaging with a supporting surface, and said sheet member including two upper end portions covered with an anti-slip material for forming the anti-slip upper end portions which are foldable relative to said sheet member and faceable downwardly for engaging with the supporting surface and for preventing said sheet member from slipping relative to the supporting surface.

2. The cushioning device as claimed in claim 1, wherein said anti-slip bottom portion of said sheet member is covered with an anti-slip material.

3. The cushioning device as claimed in claim 1, wherein said anti-slip bottom portion of said sheet member is covered with a protruded material.

4. The cushioning device as claimed in claim 1, wherein said anti-slip bottom portion of said sheet member is covered with a sticky and resilient material.

5. The cushioning device as claimed in claim 1, wherein said anti-slip upper end portions of said sheet member are covered with an anti-slip material.

6. The cushioning device as claimed in claim 1, wherein said anti-slip upper end portions of said sheet member are covered with a protruded material.

7. The cushioning device as claimed in claim 1, wherein said anti-slip upper end portions of said sheet member are covered with a sticky and resilient material.

8. The cushioning device as claimed in claim 1, wherein said sheet member includes at least one hole formed therein for hanging purposes.

9. The cushioning device as claimed in claim 1, wherein said sheet member includes two upper side portions covered with an anti-slip material for forming the anti-slip upper side portions which are foldable relative to said sheet member and faceable downwardly for engaging with the supporting surface and for preventing said sheet member from slipping relative to the supporting surface.
